(19) United States
(12) Patent Application Publication
(10) Pub. No.: US 2009/0165199 A1
(43) Pub. Date: Jul. 2, 2009

(54) Portable, disposable and recyclable toilet

(76) Inventor: Nir Heumann, Ramat-Gan (IL)

Correspondence Address: MARTIN D. MOYNIHAN d/b/a PRTSI, INC., P.O. BOX 16446, ARLINGTON, VA, 22215, US

(21) Appl. No.: 11/990,630

(22) PCT Filed: Aug. 23, 2006
(86) PCT No.: PCT/IB2006/052925

§ 371 Date: Feb. 19, 2008

Related U.S. Application Data
(60) Provisional application No. 60/710,163, filed on Aug. 23, 2005.

(51) Int. Cl. A47K 11/06; B23P 17/04; G09B 19/00

(52) U.S. Cl. 4/483; 29/428; 434/258

(57) ABSTRACT

A portable toilet comprising: (a) a base adapted to support a weight of a user;

(b) a seat positionable upon the base and adapted to support a weight of the user and including a hole through which waste may be passed by the user and (c) a waste receptacle permanently attached to the seat.

### RELATED APPLICATIONS

The present application claims the benefit under 35 USC 119(e) of U.S. Provisional Application No. 60/710,163 filed on Aug. 23, 2005; entitled “Portable, disposable and recyclable potty” by HEUMANN, Nir, the disclosure of which is incorporated herein by reference.

### FIELD OF THE INVENTION

The present invention relates to disposable devices for human waste.

### BACKGROUND OF THE INVENTION

A conveniently portable toilet would be an advantage in many situations. One example of such a situation is an excursion away from home with young children that are undergoing, or have recently completed, toilet training. In other examples adults might appreciate a similar conveniently portable toilet when a conventional toilet is not available. The prevalence of such situations has given rise to a large body of art which discloses toilets which are designed for waste disposal and/or portability.

For example, the following patents and patent applications disclose portable toilets and/or methods for disposal of human waste: AU 20032416488; DE 29909244001; FR 1551239; GB 1221586; GB 2184650; GB 2196246; GB 2224522; GB 2329579; JP 10099236; U.S. Pat. No. 2,514,537; U.S. Pat. No. 2,801,426; U.S. Pat. No. 2,804,121; U.S. Pat. No. 2,849,726; U.S. Pat. No. 2,893,017; U.S. Pat. No. 2,912,702; U.S. Pat. No. 2,974,321; U.S. Pat. No. 3,002,195; U.S. Pat. No. 3,142,847; U.S. Pat. No. 3,159,848; U.S. Pat. No. 3,235,884; U.S. Pat. No. 3,319,263; U.S. Pat. No. 3,444,563; U.S. Pat. No. 3,464,066; U.S. Pat. No. 3,492,578; U.S. Pat. No. 3,579,655; U.S. Pat. No. 3,619,822; U.S. Pat. No. 3,737,920; U.S. Pat. No. 3,950,794; U.S. Pat. No. 4,606,080; U.S. Pat. No. 4,710,989; U.S. Pat. No. 4,962,551; U.S. Pat. No. 5,040,249; U.S. Pat. No. 5,187,819; U.S. Pat. No. 5,224,223; U.S. Pat. No. 5,394,571; U.S. Pat. No. 5,611,092; U.S. Pat. No. 5,682,623; U.S. Pat. No. 5,732,418; U.S. Pat. No. 6,341,386; U.S. Pat. No. 6,647,560; WO 04/037062 and WO 89/11317. The disclosure of each application and/or patent in this list is fully incorporated herein by reference to the same extent as if each individual document had been incorporated herein by reference. This list does not purport to be exhaustive.

In addition, there are a variety of commercially available portable toilet products available. These products include, but are not limited to plastic potties, ‘on the go potty’ (Mayborn USA Inc; Providence, R.I.), ‘Travel potty’ <http://pottytrainiongsolutions.com>, ‘Inflate-A-potty’ (Brite Times Inc; Boca Raton, Fla.) and ‘Visa Potty Portable Toilet Combo’ All of these products require significant amounts of time to handle and operate.

A plastic potty is the most conventional solution in the market today for toddlers. It is usually used in the house for potty training. While its size may permit it to be stored, for example in the trunk of a car, it is not generally perceived as portable because it needs to be washed, cleaned and sanitized after every use. The term “sanitize” as used in this disclosure and the accompanying claims means to make sanitary by cleaning or sterilizing.

The “Visa Potty Portable Toilet Combo” product is similar to a conventional toilet. This product relies upon chemical liquids for the disposal of excretions.

Additional portable potties such as “Travel potty” are characterized by a relatively large size which reduces user perception of portability. Some products in this category employ a nylon bag attached below the seat which needs to be removed after use. Some products in this category are configured so that the nylon bag covers the seat during use.

Inflatable potties (e.g. “Inflate-A-potty”) are also commercially available. Typically, inflatable potties are supplied deflated in a bag or pouch. Unfolding and inflation of inflatable potties is a time consuming process. Inflatable potties are used with liner bags and share all the disadvantages of liner bags as described above.

### SUMMARY OF THE INVENTION

An aspect of some embodiments of the present invention relates to a portable toilet characterized by a waste receptacle permanently attached to the seat. Optionally, the toilet and waste receptacle are substantially completely recyclable and/or bio-degradable. In an exemplary embodiment of the invention, the waste receptacle is configured as a multilayer containment device. In an exemplary embodiment of the invention, the multilayer containment device includes a liquid impermeable outer layer and one or more of an absorbent inner layer and a hydrophilic gel.

An aspect of some embodiments of the present invention relates to a portable toilet adapted for one handed assembly. In an exemplary embodiment of the invention, the one handed assembly can be completed by an average user in 30, optionally 20, optionally 10 seconds or lesser or greater or intermediate times. According to some exemplary embodiments of the invention, assembly is accomplished without engaging any interlocking parts. According to other exemplary embodiments of the invention, assembly includes joining 1, optionally 2, optionally 3 or more pairs of interlocking parts. According to some exemplary embodiments of the invention, assembly includes 1, optionally 2, optionally 3 or more locking actions.

The phrase “one handed assembly” as used in this specification and the accompanying claims indicates that there is no need for precise manipulation with two hands to align parts. In some cases parts are aligned by leaning a portion of the toilet on the floor.

An aspect of some embodiments of the present invention relates to a portable disposable toilet including a base characterized by a sloped side between a larger cross section which contacts the floor at at least three points and a smaller cross section which contacts the seat at at least three points. Optionally, this configuration contributes to mechanical stability of the portable toilet. Optionally, the base is in the form of a truncated cone or a truncated pyramid (e.g. square pyramid or tetrahedron).

For purposes of this specification and the accompanying claims, the term “disposable” means “designed to be disposed of after use”.

According to exemplary embodiments of the invention, the toilet is constructed to support the weight of an adult (e.g. 125, optionally 150, optionally 200 pounds or intermediate or greater weights) or is configured as a potty constructed to support the weight of a child (e.g. 25, optionally 50, optionally 125 pounds or intermediate or lesser values) when assembled. Optionally, the toilet is constructed for use indoors and/or outdoors.

In an exemplary embodiment of the invention, the base is assembled by unfolding. Optionally, some or all folded joints pop back to a predetermined position. In an exemplary embodiment of the invention, materials with a memory are employed in construction (e.g. corrugated cardboard) to facilitate this pop back.

In an exemplary embodiment of the invention, the seat is stored in a folded condition and unfolded for use. Optionally, the seat is folded only once in its stored condition.

Optionally, the seat is laid upon the base or is locked to the base. Locking of the seat to the base may be accomplished, for example, by means of 1, optionally 2 or more matching tabs and grooves. According to other exemplary embodiments of the invention, locking may be accomplished by, for example, a sticker, a coupler (male/female), one or more button/buttonhole pairs, magnets with opposite polarity, combinations thereof or functionally similar substitutes therefore.

Alternatively or additionally, matching tabs and grooves are employed to construct, assemble or “lock together” the base.

In an exemplary embodiment of the invention, assembly of the toilet includes zero, optionally 1, optionally two or more locking steps. In an exemplary embodiment of the invention, assembly may be completed with one hand, for example while holding a child in the other hand.

An aspect of some embodiments of the present invention relates to a toilet seat with a permanently attached waste receptacle. In an exemplary embodiment of the invention, the seat is foldable. Optionally, the seat and waste receptacle are substantially completely recyclable and/or biodegradable. Optionally, the waste receptacle is configured as a multilayer containment device. In an exemplary embodiment of the invention, folding of the seat after use closes the waste receptacle. Optionally, closing reduces leaking of contents and/or permits convenient transfer to a disposal location (e.g. garbage can or recycling bin). In an exemplary embodiment of the invention, closing of the waste receptacle by folding the seat reduces contact with waste contained in the receptacle. Optionally, the seat is locked in a folded configuration after use by matching tabs and grooves or alternate locking mechanisms as described above. In an exemplary embodiment of the invention, the folding substantially seals the waste receptacle.

According to some exemplary embodiments of the invention, a foldable seat is characterized by a permanently attached waste receptacle. Permanent attachment of the waste receptacle to the seat contributes to rapid set-up and/or convenient disposal after use. In an exemplary embodiment of the invention, the seat is easily joinable to and removable from a separate base, optionally a single use or re-usable or permanent base. Optionally, joining and/or removal are accomplished with one hand. In other embodiments of the invention, the seat/waste receptacle are provided attached to a base. Optionally, the seat and/or base are provided folded. Optionally, folding facilitates easy storage.

In an exemplary embodiment of the invention, folding of the seat and/or base during storage prior to use reduces at least one dimension of the seat and/or base. Optionally, reducing at least one dimension, optionally two dimensions, contributes to a user perception of portability. In an exemplary embodiment of the invention, the user perception of portability increases as a degree of flatness of the folded seat and/or base increases.

In an exemplary embodiment of the invention, unfolding of the seat during use expands the seat to anatomically appropriate dimensions.

An aspect of some embodiments of the present invention relates to a portable toilet seat characterized by a comfort layer. In an exemplary embodiment of the invention, the comfort layer does not include a non-porous plastic layer or foil layer which contacts the skin of a user. In an exemplary embodiment of the invention, the comfort layer includes padding and/or cushioning and/or wicking materials and/or non-stick materials. Optionally, these materials are selected to reduce a user perception of stickiness. In exemplary embodiments of the invention, the comfort layer is installed on a seat configured for use with a removable waste bag or a seat equipped with a permanently attached waste receptacle.

An aspect of some embodiments of the present invention relates to a portable toilet characterized by a seat adapted for removal after use. Optionally, the seat is removed by tearing. Optionally, the seat is adapted for disposal and/or recycling separately from a base of the toilet. In an exemplary embodiment of the invention, the seat includes a permanently attached waste container. In an exemplary embodiment of the invention, the seat includes a permanently attached comfort layer. Optionally, the waste container and the comfort layer contain at least one contiguous layer.

An aspect of some embodiments of the present invention relates to a behavior modification kit including a disposable toilet and a prize. In an exemplary embodiment of the invention, the prize is a sticker which a child receives as a reward for using the toilet. Optionally, the sticker is provided on the toilet and may be removed after the toilet is used. A child may, for example, wear the sticker on their shirt.

An aspect of some embodiments of the present invention relates to a behavior modification kit including a diaper, optionally disposable, and a prize. In an exemplary embodiment of the invention, the prize is a sticker which a child receives as a reward for not wetting and/or soiling the diaper. Optionally, the sticker is provided on the diaper and may be removed after the toilet is used. A child may, for example wear the sticker on their shirt.

In an exemplary embodiment of the invention, there is provided a portable toilet, the toilet comprising,

(a) a base adapted to support a weight of a user;

(b) a seat positionable upon the base and adapted to support a weight of the user and including a hole through which waste may be passed by the user; and

(c) a waste receptacle permanently attached to the seat.

Optionally, the toilet is supplied as a kit comprising substantially flat pieces.

Optionally, the pieces are configured so as to be assembled using one hand.

In an exemplary embodiment of the invention, there is provided a portable toilet characterized by a larger cross section where it contacts a floor than where it contacts a seat.

Optionally, the toilet is constructed primarily of biodegradable materials.

Optionally, the toilet is constructed primarily of recyclable materials.

In an exemplary embodiment of the invention, there is provided a single sheet of corrugated cardboard adapted for assembly into a toilet.

Optionally, the adaptation facilitates the assembly with a single hand of an assembler.

Optionally, the adaptation facilitates the assembly by an assembler in a time not exceeding 15 seconds.

Optionally, the adaptation facilitates removal of the seat from the base after use.

Optionally, the seat is locked with at least one locking component.

Optionally, the base is locked with at least one locking component.

Optionally, the seat and the base are locked together by at least one locking component.

Optionally, the seat and the base are locked together by at least two locking components.

Optionally, the seat characterized by a permanently attached waste receptacle.

Optionally, the waste receptacle includes an absorbent inner layer and a liquid impermeable outer layer.

In an exemplary embodiment of the invention, there is provided a foldable disposable toilet seat, wherein a fold line is positioned so that folding of the seat along the fold line closes the waste receptacle.

In an exemplary embodiment of the invention, there is provided a portable toilet seat, the seat characterized by a comfort layer positioned to contact exposed skin of a user during use.

Optionally, the comfort layer comprises padding.

Optionally, the comfort layer comprises wicking material.

Optionally, the comfort layer comprises at least one layer contiguous with a waste receptacle.

Optionally, assembly does not include operation of a locking mechanism.

Optionally, assembly relies at least partially upon a memory of materials employed in constructing at least a portion of the toilet.

Optionally, the seat is characterized as being foldable.

Optionally, the seat is characterized as being rigid.

Optionally, the comfort layer covers an edge of a waste aperture.

In an exemplary embodiment of the invention, there is provided a method of assembling a portable toilet, the method comprising:
a) erecting a base by assembling no more than 3 matching parts; and
b) positioning a seat on the base;

wherein a waste receptacle is provided by the performance of (a) and (b).

Optionally, the assembling is performed with 1 hand.

Optionally, the method is performed in not more than 15 seconds.

In an exemplary embodiment of the invention, there is provided a behavior modification kit, the kit comprising:
a) a single use toilet; and
b) a prize;
wherein the prize is designated as a reward for using the toilet.

Optionally, the prize includes a sticker.

Optionally, the sticker is provided on the toilet.

In an exemplary embodiment of the invention, there is provided a behavior modification kit, the kit comprising:
a) a diaper; and
b) a prize;
wherein the prize is designated as a reward for keeping the diaper clean.

Optionally, the prize includes a sticker.

Optionally, the diaper is disposable.

Optionally, the sticker is provided on the diaper.

In an exemplary embodiment of the invention, there is provided a behavior modification kit, the kit comprising:
a) a single use toilet;.
b) a toilet prize designated as a reward for using the toilet;
c) a diaper; and
b) a diaper prize designated as a reward for keeping the diaper clean.

Optionally, the diaper is disposable.

### BRIEF DESCRIPTION OF THE FIGURES

In the Figures, identical structures, elements or parts that appear in more than one Figure are generally labeled with the same numeral in all the Figures in which they appear. Dimensions of components and features shown in the Figures are chosen for convenience and clarity of presentation and are not necessarily shown to scale. The Figures are listed below.

FIG. 1 is a simplified flow diagram illustrating a sequence of events performed by a user during use of an exemplary embodiment of the invention;

FIG. 2 is a top view of a portable toilet according to an exemplary embodiment of the invention showing a seat offset from a base;

FIG. 3 is a perspective view of a portable toilet according to an exemplary embodiment of the invention showing the seat being fitted to the base using an optional tab and optional groove;

FIG. 4 is a perspective view of a portable toilet as depicted in FIG. 3 with the seat inverted;

FIG. 5 is a perspective view of a portable toilet as depicted in FIG. 3 with the optional tab inserted in the optional groove and featuring an optional comfort layer;

FIG. 6 is a perspective view of a portable toilet as depicted in FIG. 3 illustrating removal and folding of the seat;

FIG. 7 is a perspective view of a foldable portable toilet seat according to an exemplary embodiment of the invention;

FIGS. 8 and 9 are perspective views of kits for construction of a portable toilet according to exemplary embodiments of the invention;

FIG. 10 illustrates a foldable portable toilet according to an exemplary embodiment of the invention supplied as a single sheet; and

FIG. 11 is a perspective view of a foldable portable toilet seat according to an exemplary embodiment of the invention.

### DETAILED DESCRIPTION OF EXEMPLARY EMBODIMENTS

### Exemplary Use Scenario

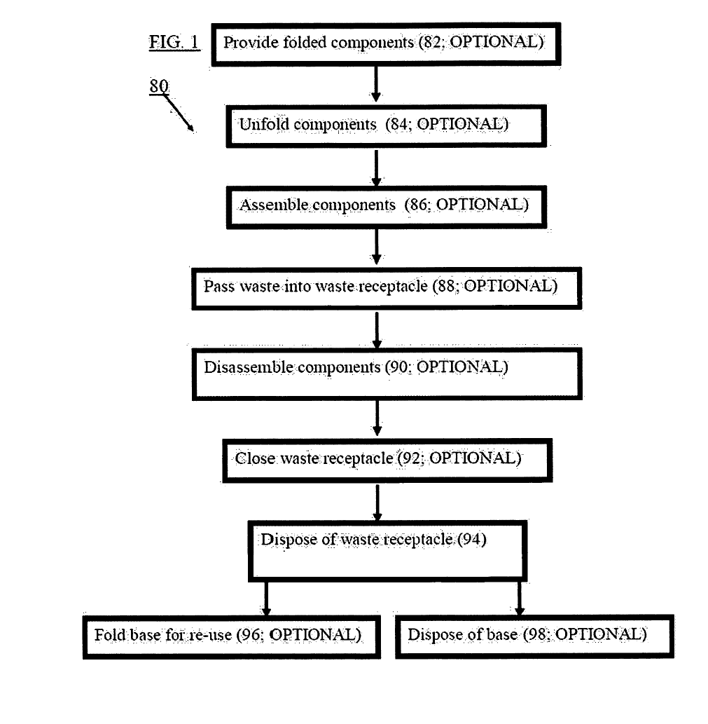

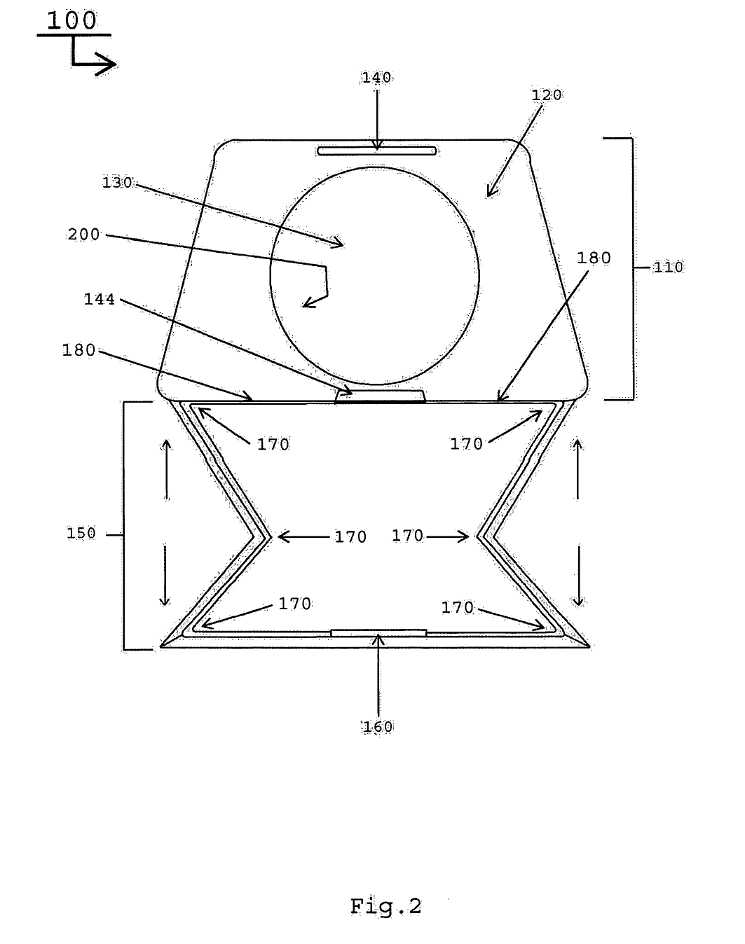

FIG. 1 is a. simplified flow diagram illustrating a sequence of events 80 performed by a user of a portable toilet 100 according to an exemplary embodiment of the invention during use. Toilet 100 is depicted in FIGS. 2; 3; 4; 5, 6, and 10 and described in detail hereinbelow.

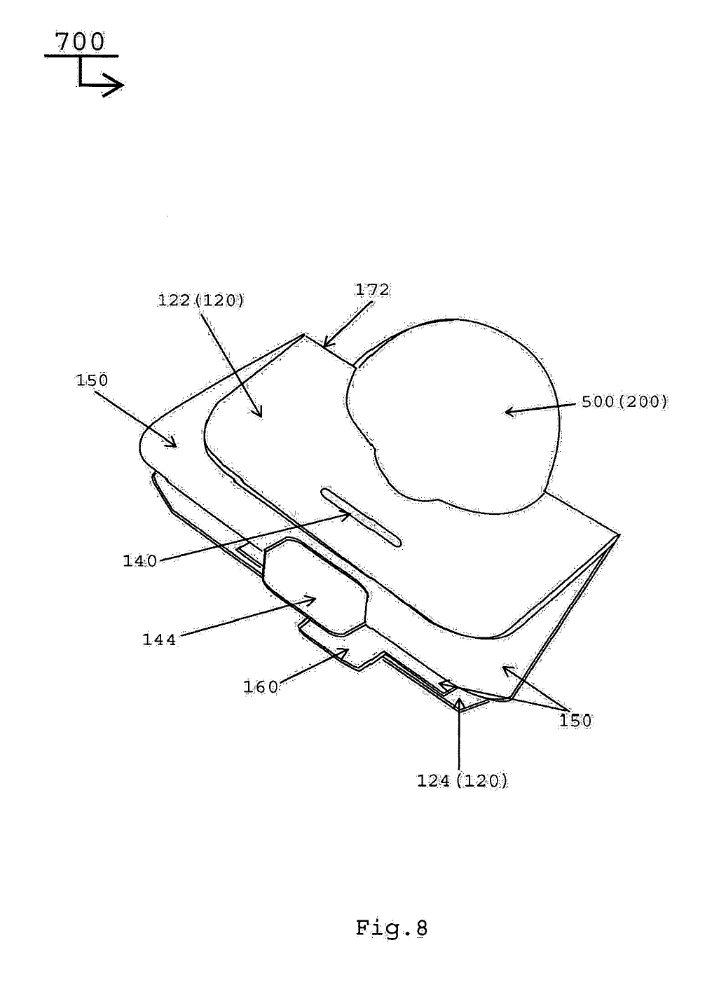

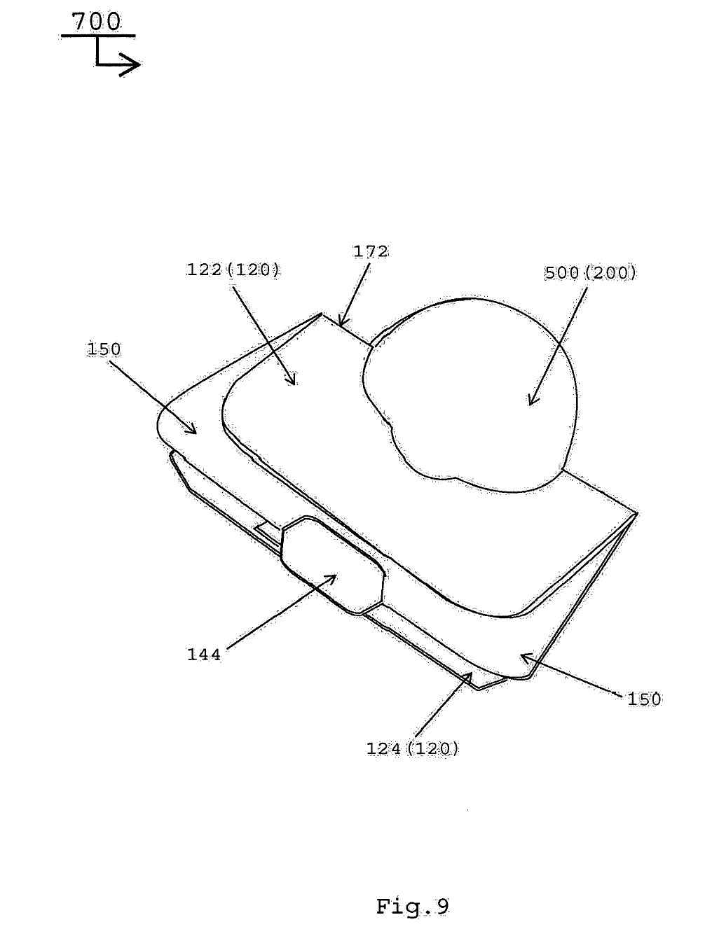

Optionally, toilet 100 is provided 82 as a kit 700 comprising a set of folded or collapsed components as seen, for example in FIG. 8 and/or FIG. 9. Optionally, the folded components are provided in a bag or envelope. In an exemplary embodiment of the invention, a seat component and a base component are provided. In an exemplary embodiment of the invention, the seat component includes a waste receptacle which is integrally formed with or permanently attached to the seat. Optionally, the seat and/or base are constructed primarily of cardboard or fiberboard.

If the toilet is provided as folded components, they are unfolded 84 as shown, for example, in FIG. 2. If the components are provided in a bag or envelope, they are removed from the bag/envelope prior to unfolding 84.

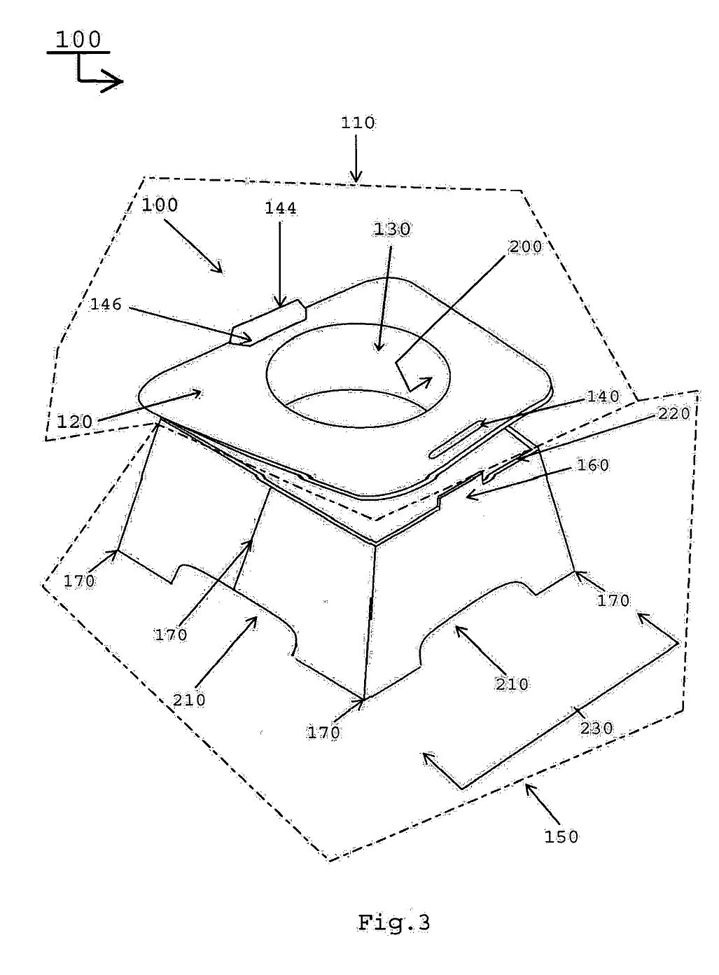

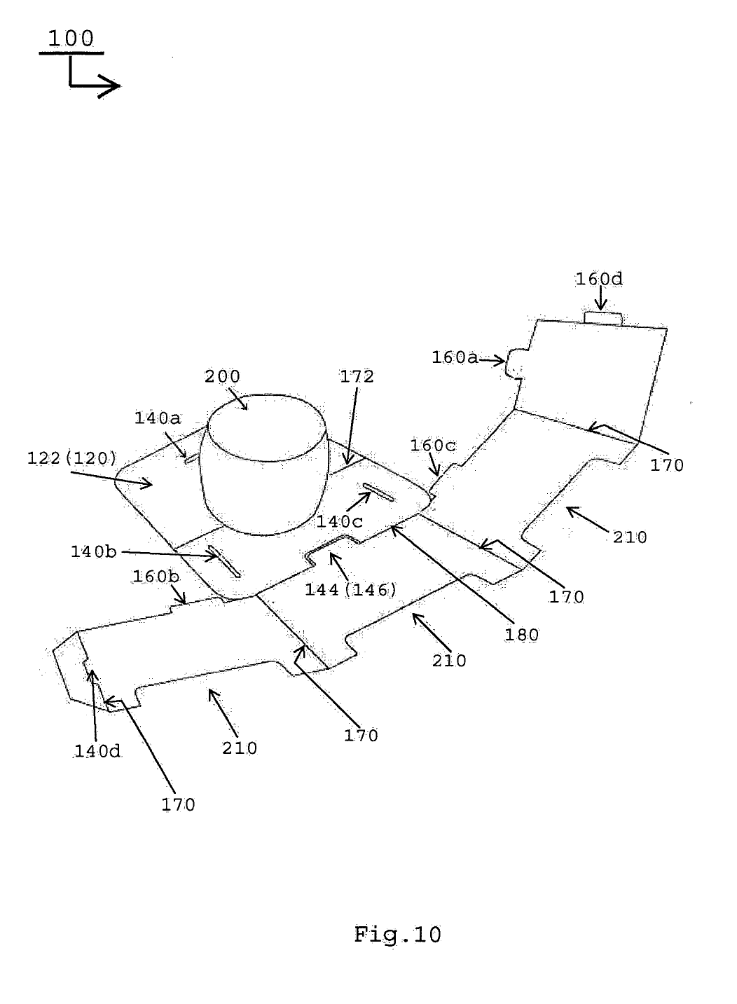

If the toilet is provided as components, they are assembled 86 as shown, for example, in FIGS. 3 and 10. In an exemplary embodiment of the invention, assembly is accomplished in less than 15 seconds, optionally less than 10 seconds or intermediate or greater times. In an exemplary embodiment of the invention, assembly includes unfolding. Optionally, assembly includes joining together of interlocking pieces and/or placing a seat on a base. Optionally, the toilet is provided as an assembled 3 dimensional unit ready for use. Optionally, the toilet is provided as single flat sheet which is foldable to create the 3 dimensional unit.

At this stage, the toilet is ready for use and waste may be passed 88 through an opening in the seat component into the waste receptacle.

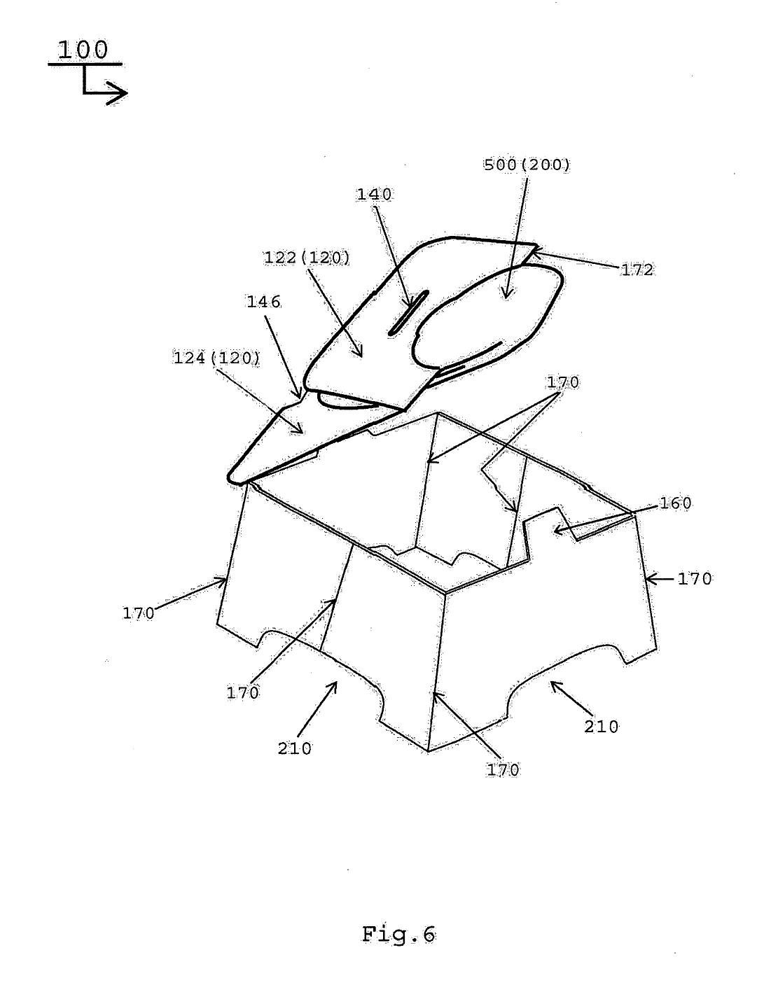

After use, the components are optionally disassembled 90 as shown, for example, in FIG. 6. In an exemplary embodiment of the invention, the seat is removed from the base at this stage. Optionally, removal may involve tearing (e.g. of tab 160, or of a tear strip) or may involve use of a pull string which tears as it is pulled.

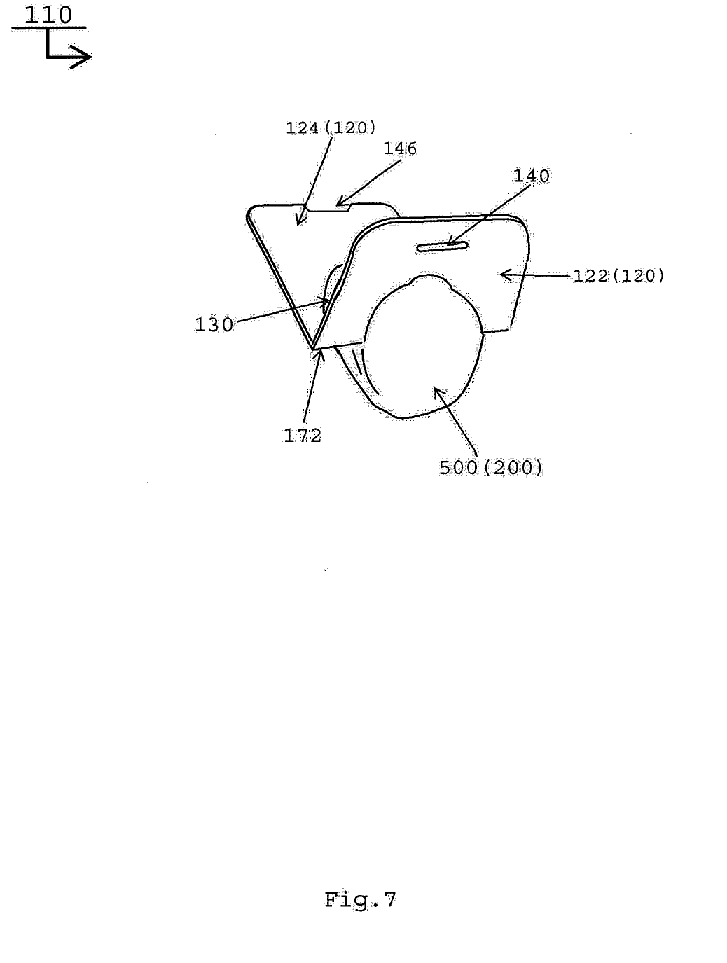

In an exemplary embodiment of the invention, the waste receptacle is closed 92 after use as best seen in FIGS. 6 and 7. Optionally, closure makes waste handling easier and/or less unpleasant by reducing contact with waste and/or odors emanating from the waste. In an exemplary embodiment of the invention, the waste receptacle is closed by folding the seat to which the receptacle is attached. In an exemplary embodiment of the invention, closure by folding is accomplished without undesirable contact with waste and/or odors emanating from the waste. Optionally, there is no sealing.

After use, the user disposes 94 of the waste receptacle. Optionally, disposal may be in a bag or envelope in which folded components were provided 82 prior to use.

The base, may optionally be disposed of 98 or folded 96 (e.g. opposite of procedure depicted in FIG. 2) for subsequent re-use. Optionally, disposal of the base may be in a bag or envelope in which folded components were provided 82 prior to use. Optionally, disposal may be in a recycling bin.

### General Description of Exemplary Portable Toilet

Referring now to FIG. 2, portable toilet 100 is presented in a top view in which a seat component 110 is shown offset from a base component 150. Base 150 is depicted as a folded, substantially flat, component which unfolds to produce a polygonal structure with a rectangular cross-section. In an exemplary embodiment of the invention, the base is assembled by unfolding as most clearly seen in FIG. 2. In the pictured embodiment base 150 is provided as a collapsed truncated square pyramid. All four corners of the pyramid serve as flex points 170. In the pictured exemplary embodiment, two opposite sides of the pyramid are provided with additional flex points 170 at their midline (FIG. 3). As indicated by the arrows in FIG. 2, unfolding occurs easily because of memory of materials employed in construction of base 150. A base 150 of the type depicted in FIG. 2 can be unfolded easily with one hand (e.g. while holding a child in the other hand) in a matter of seconds. Flex points 170 may be formed, for example, by making serrations or partial cuts in the corrugated cardboard.

Seat component 110 includes a support area 120 for a user to sit upon. Support area 120 surrounds a waste aperture 130 in seat 110. Although waste aperture 130 is depicted as circular, it may optionally be oval. In an exemplary embodiment of the invention, an oval aperture 130 is employed in a seat 110 for a child's potty.

In an exemplary embodiment of the invention, support area 120 has a width of 20-40 cm including aperture 130 and is designed for use by children. Optionally, aperture 130 has a width of 10-20 cm.

In an exemplary embodiment of the invention, support area 120 has a width of 30-50 cm including aperture 130 and is designed for use by adults. Optionally, aperture 130 has a width of 20-30 cm.

When seat 110 is positioned on base 150, an upper edge 220 (FIG. 3) of base 150 is positioned beneath support area 120 so as to support a weight of a seated user of toilet 100. Optionally, support area 120 extends beyond upper edges 220 of base 150. A support area extends beyond upper edges 220 of base 150 may be employed, for example, in embodiments of the invention in which seat 110 is not locked to base 150.

Optionally, toilet 100 includes one or more tabs, for example a tab 160. These tabs can be inserted in matching grooves 140 as a means of locking seat 110 on base 150 and/or as a means of preventing lateral and/or rotational displacement of seat 110 with respect to base 150. In the illustrated embodiment a single tab/groove pair is shown, although in other exemplary embodiments of the invention, two or three or more tab/groove pairs may be provided. Other locking mechanisms may be substituted for tabs/grooves as explained above.

Optionally, a weight of the user serves to hold seat 110 on base 150 during use and no tabs 160/grooves 140 are provided.

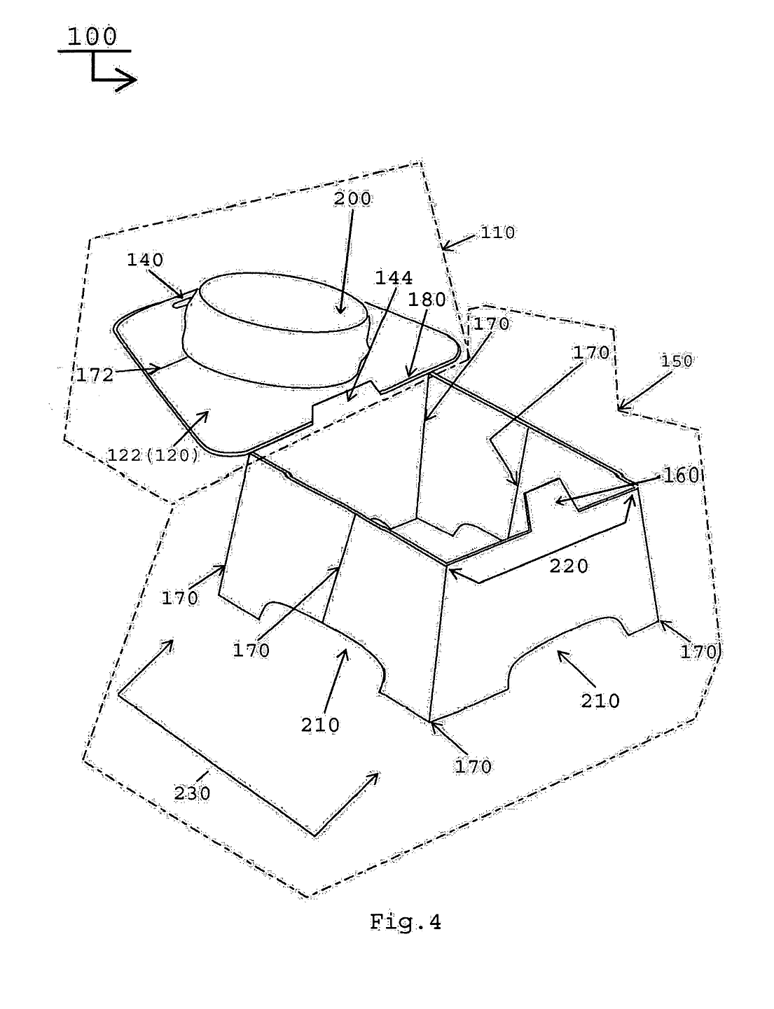

Optionally, small tabs protrude upwards from edge 220 of base 150 to fit in recesses 140 of underside 122 (FIG. 4) support area 120 of seat 110 to keep seat 110 on base 150 (see FIG. 10 and its description below). In an exemplary embodiment of the invention, these tabs do not protrude through support area 120.

Optionally, underside 122 (FIG. 4) of support area 120 of seat 110 is etched with a groove that engages and retains upper edges 220 of base 150 to keep seat 110 on base 150.

FIG. 3 is a perspective view of toilet 100 according to an exemplary embodiment of the invention in an intermediate stage of assembly 86, showing seat 110 being fitted to base 150 using optional tab 160 and optional groove 140. Optionally, tab 160 is positioned medially with respect to a front edge 220 of base 150. In an exemplary embodiment of the invention, tab 160 serves as a splash guard if toilet 100 is used by a male child.

Optionally, tab 160 is positioned medially with respect to a rear edge 220 of base 150. In an exemplary embodiment of the invention, tab 160 serves as tactile position indicator which serves to indicate to a user seating themselves on seat 110 that they have reached a rear boundary of support area 120.

In another embodiment of the invention, tactile position indicator 144 is provided separately as a raisable flap 144 in a perforated well 146 on a rear edge of seat 110. (See FIGS. 4; 5; 6 and 10).

Flex points 170 are fully opened at this stage so that base 150 is shaped to conform to seat 110. In FIG. 3, waste receptacle 200 is visible below waste aperture 130 in support area 120 of seat 110.

FIG. 4 is a perspective view of portable toilet 100 as depicted in FIG. 3 with seat 110 inverted so that waste receptacle 200 is more clearly visible. In the pictured embodiment, a perforated seam 180 is visible between seat 110 and base 150.

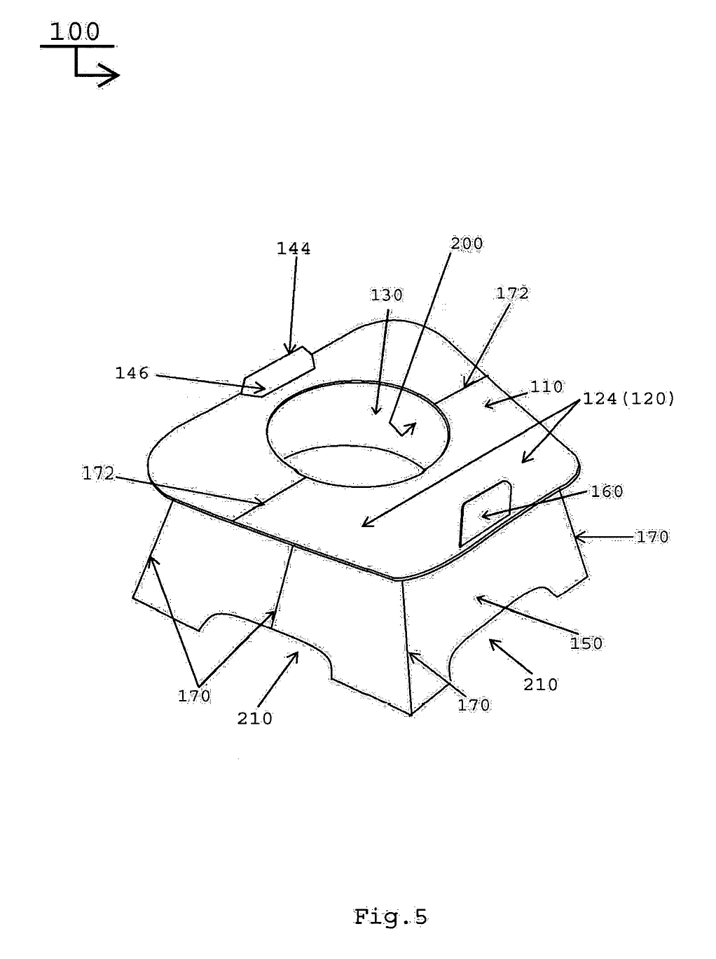

FIG. 5 is a perspective view of toilet 100 fully assembled and ready for use. In this view a comfort layer 124 is depicted covering support area 120 of seat 110. Tab 160 is seen protruding through groove 140 (FIG. 4). Tactile indicator 144 is clearly visible in this view.

FIG. 6 is a perspective view of toilet 100 illustrating disassembly 90 and closing 92 of seat 110 and waste receptacle 200. FIG. 7 illustrates closing 92 of waste receptacle 200 in greater detail.

Some particular exemplary and/or optional features of toilet 100 which are depicted in FIGS. 2-6 and have not been described hereinabove are described hereinbelow in sections entitled seat features, waste receptacle features and base features.

### Exemplary Seat Features

In an exemplary embodiment of the invention, unfolding 84 (FIG. 1) includes unfolding seat 110. Optionally, seat 110 is folded only once in its stored condition. In the exemplary embodiment of seat 110 of toilet 100 illustrated in FIGS. 4, 5 and 6, folding is along fold line 172. In embodiments of seat 110 constructed of corrugated cardboard, fold line 172 may be created by scoring underside 122 of support area 120 (FIG. 4).

In an exemplary embodiment of the invention, seat 110 is provided connected to base 150. Optionally, seat 110 is adapted for removal from base 150 by scoring, perforated seam 180, a tear line or a tear string.

In an exemplary embodiment of the invention, portable seat 110 includes a permanently attached waste receptacle 200. In an exemplary embodiment of the invention, waste receptacle 200 is configured as a multilayer containment device as describe below under “waste receptacle features”. Permanent attachment of waste receptacle 200 may contribute to rapid set-up of toilet 100 and/or convenient disposal after use. In other preferred embodiments of the invention, attachable/detachable, for example by means of glue or adhesive.

In an exemplary embodiment of the invention, portable seat 110 is easily joinable to and/or removable from base 150. Optional joining/removal embodiments are described below under “Assembly”.

In an exemplary embodiment of the invention, folding of seat 110, for example along fold line 172, reduces a dimension of seat 110. In an exemplary embodiment of the invention, folding of seat 110 reduces one dimension of seat 110 to 10, optionally 15, optionally 20, optionally 25 cm or lesser or greater or intermediate lengths. Optionally, the reduced dimension permits storage prior to use in a smaller space. Optionally, the capacity to be stored in a smaller space contributes to portability of seat 110 and/or toilet 100.

In an exemplary embodiment of the invention, unfolding of seat 110 during use expands seat 110 to anatomically appropriate dimensions. Optionally, unfolding may include opening 1 or 2 or 3 or more folds. A child sized seat may be, for example 20×20 cm, optionally 30×30 cm or lesser or intermediate or greater sizes. Optionally, seat 110 is rectangular (e.g. 20×30 cm). An adult sized seat may be, for example 35×35 cm, optionally 40×40 cm, optionally 50×50 cm or lesser or intermediate or greater sizes.

As seen, for example, in FIGS. 6 and 7, folding of seat 110 after use can serve to close waste receptacle 200. Closing 92 of receptacle 200 has numerous advantages including, but not limited to, contributing to a reduction on leaking of contents, permitting convenient transfer to a disposal location (e.g. garbage can or recycling bin), and reducing exposure to unpleasant smells emanating from waste contained in receptacle 200.

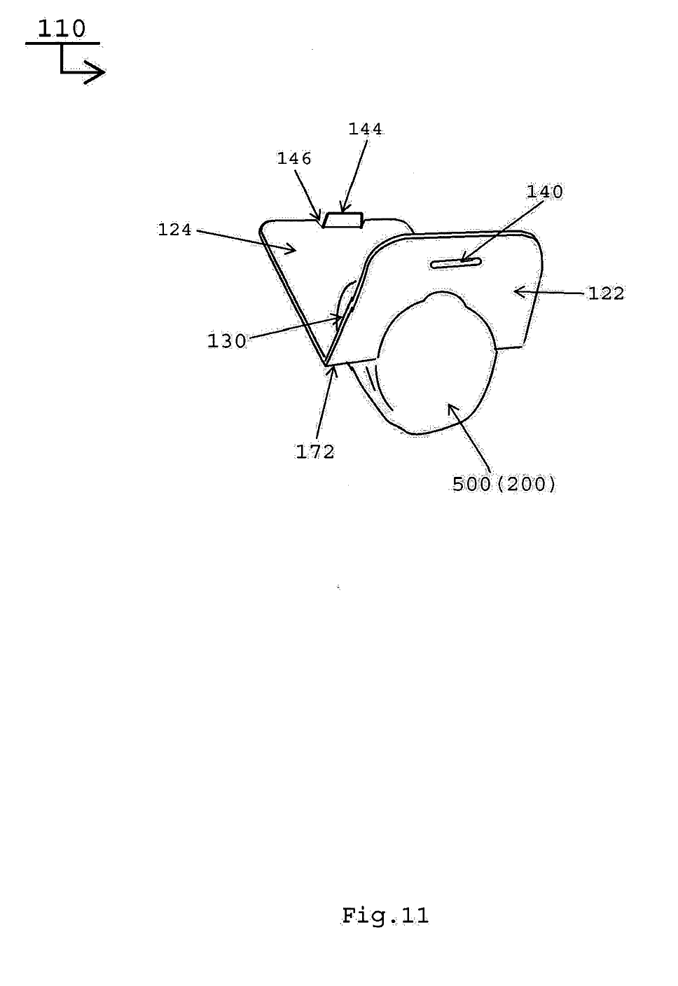

In an exemplary embodiment of the invention, closing 92 of waste receptacle 200 by folding seat 110 reduces contact with waste contained in receptacle 200. Optionally, seat 110 is locked in a folded configuration after use by matching tabs and grooves. In an exemplary embodiment of the invention, tab 144 is adapted to engage groove 140 (FIG. 11) serves to lock seat 110 in a closed configuration. Alternatively or additionally, seat 110 is adapted for sealing and/or locking in a closed position bother means (e.g. using hook and eye closures or crack and peel adhesive stickers).

In an exemplary embodiment of the invention, handling of a rigid edge of folded seat 110 is more convenient than gathering edges of a waste bag containing waste. Convenience may stem from ease of alignment of rigid edges to effect closure. This convenience is expected, in some embodiments, to be readily apparent to users and contribute to user acceptance of those embodiments of the invention characterized by this feature.

In an exemplary embodiment of the invention, portable toilet seat 110 includes a comfort layer 124 (FIG. 5) which covers at least a portion of support area 120.

Exemplary Comfort Layer Features

In an exemplary embodiment of the invention, comfort layer 124 includes a surface of woven or non-woven fabric deployed to contact skin of a user seated on support area 120. Alternatively or additionally, comfort layer 124 includes cushioning or padding material.

In an exemplary embodiment of the invention, the fabric layer is 1 mm, optionally 2 mm, optionally 3 mm thick or lesser or greater or intermediate thickness.

In an exemplary embodiment of the invention, the cushioning or padding material is 1 mm, optionally 2 mm, optionally 3 mm thick or lesser or greater or intermediate thickness.

Optionally, comfort layer 124 does not include plastics or other materials which might stick to or irritate the skin of a user upon contact (e.g. non porous plastics).

In an exemplary embodiment of the invention, comfort layer 124 includes wicking materials, for example, fabric. Optionally, the wicking materials absorb waste (e.g. drops) which land on seat 110. In an exemplary embodiment of the invention, a non woven fabric is employed as a wicking material.

In an exemplary embodiment of the invention, comfort layer 124 is integrally formed with seat 110. Optionally, comfort layer 124 is contiguous with waste receptacle 200 permanently attached to seat 110. In an exemplary embodiment of the invention, comfort layer 124 is installed on a seat 110 configured for use with a removable waste bag.

### Exemplary Waste Receptacle Features

In some exemplary embodiments of the invention, a function of waste receptacle 200 is adapted to receive and retain waste while minimizing user contact and/or exposure to the waste during use of toilet 100 and/or separation of seat 110 from base 150 and/or disposal of receptacle 200. For at least these reasons, waste receptacle 200 is optionally provided as a multilayer containment device including a liquid impermeable outer layer 500 and one or more of an absorbent inner layer and a hydrophilic gel. In an exemplary embodiment of the invention, the liquid impermeable outer layer 500 prevents liquid waste from leaking from receptacle 200. In an exemplary embodiment of the invention, the absorbent inner layer and/or hydrophilic gel soak up liquid waste and/or partially dry more solid waste. Optionally, the configuration of layers is similar to that employed in constructing a disposable diaper. Optionally, materials employed in construction of receptacle 200 are biodegradable.

In an exemplary embodiment of the invention, waste receptacle 200 is characterized by a depth of 10 cm, optionally 20 cm, optionally 30 cm or lesser or intermediate or greater depths. According to various exemplary embodiments of the invention, receptacle 200 may be configured as, for example, a cylinder, a hemisphere or an inverted cone.

In an exemplary embodiment of the invention, waste receptacle 200 is characterized by a volume of 0.5 liter, optionally 2 liter, optionally 3 liter or lesser or intermediate or greater volumes.

For similar reasons, receptacle 200 is integrally formed with or permanently attached to seat 110. Optionally, receptacle 200 is circumferentially sealed to aperture 130 in support surface 120. Attachment or sealing of receptacle 200 to seat 110 may be, for example by one or more of gluing, sewing, welding or ultrasonic joining.

In an exemplary embodiment of the invention, sewing of waste receptacle 200 to seat 110 creates a bond of sufficient strength to keep receptacle 200 attached to seat 110 even if 1, optionally 2, optionally 3 or more kilos of waste or intermediate or greater amounts of waste are deposited in receptacle 200.

Alternatively or additionally, in some embodiments of the invention, sewing reduces a need for glue making toilet 100 environmentally friendly and reducing exposure of children to toxins.

In some exemplary embodiments of the invention, comfort layer 124 and waste receptacle 200 are contiguous. Optionally, the absorbent inner layer of waste receptacle 200 extends beyond edges of waste aperture 130 and covers support area 120. The portions of the absorbent layer covering support area 120 comprise part of comfort layer 124. Optionally, edges of comfort layer 124 are folded over edges of support area 120 and fastened to underside 122 (FIG. 4) of support area 120. Fastening may be, for example by one or more of riveting, gluing, sewing, welding and/or ultrasonic joining.

In an exemplary embodiment of the invention, comfort layer 124 covers a circumferential inner edge of aperture 130 of waste receptacle 200. This optional feature can reduce unwanted irritation and/or abrasion from contact between exposed skin and, for example, an exposed edge of corrugated cardboard.

In an exemplary embodiment of the invention, receptacle 200 is constructed as a multi-layer containment device. Those skilled in the art of disposable diaper manufacture are familiar with design considerations relevant to construction of multi-layer containment device and will be able to design and construct receptacles 200 suitable for incorporation into the various embodiments of the invention. Optionally, the amount of absorbent materials included in receptacle 200 may be less than included in a disposable diaper designed to be worn for several hours or more than included in a disposable diaper so that several users may take advantage of a single receptacle 200 in succession.

### Base Features

According to exemplary embodiments of the invention, base 150 serves to support seat 110 during use. In order to impart sufficient mechanical strength to the base to support the weight of a user seated on seat 110 while limiting the amount of materials employed in construction of base 150, and/or to impart stability to the base, exemplary embodiments of the invention optionally include one or more of the following features.

In an exemplary embodiment of the invention, base 150 is characterized by a larger cross section where it contacts or is adjacent to the floor than where it contacts seat 110. This optional feature is seen clearly in FIG. 3 where a bottom edge 230 is significantly longer than a top edge 220 of each side of seat 150.

The difference in length between edges 230 and 220 produces a sloped side between the larger cross section which contacts the floor and the smaller cross section which contacts seat 110 when base 150 is assembled. This sloped side can contribute to mechanical stability of base 150. Optionally, the sloped sides reduce a tendency of the base to buckle under the weight of a user.

Alternatively or additionally, sloped sides of base 150 make toilet 100 more visually similar to a “real” potty than to a box. Optionally, a seat 110 wider than base 150 can make toilet 100 more visually similar to a “real” potty than to a box. In an exemplary embodiment of the invention, 150 is characterized by rounded corners or a rounded configuration.

In an exemplary embodiment of the invention, base 150 is constructed of corrugated cardboard. Optionally, the corrugations are oriented to give greater mechanical stability, for example, perpendicular to an anticipated gravitational force application vector. Use of cardboard sheet in which the corrugations are substantially perpendicular to edges 220 and 230 optionally contributes to a high degree of mechanical strength per unit of construction material.

Using, for example, 1 or 2-ply corrugated cardboard, one of ordinary skill in the art will be able to construct a base 150 for a potty 100 configured to support the weight of a child (e.g. 25, optionally 50, optionally 100 pounds or intermediate or lesser values). A potty 100 adapted for use by children may be constructed with a height of 15, optionally 20, optionally 30 cm or lesser or intermediate values.

Using 3 or 4 ply corrugated cardboard, one of ordinary skill in the art will be able to construct a base 150 for a toilet configured to support the weight of an adult (e.g. 100, optionally 150, optionally 200 pounds or intermediate or greater values. In an exemplary embodiment of the invention, adult toilet 100 features a taller base). A toilet 100 adapted for use by adults may be constructed with a height of 30, optionally 40, optionally 50 cm or lesser or intermediate values.

In an exemplary embodiment of the invention, a child sized potty 100 is constructed of B-flute corrugated cardboard with a wavelength of 6 mm and wave height of 2.5 mm. Optionally, a base 150 and/or seat 100 constructed of this type of cardboard can support 50-60 kg or lesser or greater weights

In an exemplary embodiment of the invention, an adult sized toilet 100 is constructed of C-flute reinforced corrugated cardboard with a wavelength of 7 mm and wave height of 3.7 mm. Optionally, a base 150 and/or seat 110 constructed of this type of cardboard can support 100 kg or lesser or greater weights.

In other embodiments of the invention, double-wall (e.g. AB, CB, AC, AA fluting combination) or triple-wall (e.g. AAB, CCB and BAE constructions) cardboard is employed to construct a base 150 and/or seat 110 which can support 180-200 kg or lesser or intermediate or greater weights.

One of ordinary skill in the art of mechanical engineering will be able to select suitable construction materials in terms of corrugation wavelength, corrugation wave height, corrugation wave layers, reinforcement and density based upon one or more desired performance characteristics. Optionally, lamination contributes to the strength of seat 110 and/or base 150.

Optionally, base 150 is configured for use indoors and/or outdoors. In an exemplary embodiment of the invention, an indoor configuration features a base which has 6, optionally, 8, optionally 12 or intermediate or greater numbers of contact points with a floor. Optionally, the indoor configuration provides greater stability on level surfaces. A base 150 as depicted in FIGS. 3, 4, 5, 6 and 10 without optional notches 210 contacts a level floor along the entire length of lower edge 230 on all four sides of base 150. This circumferential floor contact is substantially an infinite number of contact points and provides greater mechanical strength. In an exemplary embodiment of the invention, an outdoor configuration features a base 150 which includes 16, optionally 8, optionally 6, optionally 4, optionally 3 contact points with a floor. Optionally, the outdoor configuration is suitable for use on roughened or un-level surfaces. FIGS. 3, 4, 5, 6 and 10 depict optional raised areas 210 which effectively reduce the contact points to the four comers of the base. In an exemplary embodiment of the invention, optional notches 210 are provided as serrated “pop-outs” which can be quickly removed for outdoor use.

In an exemplary embodiment of the invention, the base is configured to switch from a storage mode to a use mode in less than 15, optionally less than 10, optionally less than 5 seconds or intermediate or lesser times. Optionally, switching results from a manual input of energy and/or a memory of folded materials employed in construction.

In its folded storage mode, base 150 is substantially flat and is characterized by a thickness of 1 cm, optionally 3 cm, optionally 5 cm or lesser or greater or intermediate thickness. The flatness makes base 150 storable in a small volume and contributes to portability and/or convenient storage and to the perception of portability (e.g. in a knapsack, purse or diaper bag).

### Assembly

FIGS. 8 and 9 illustrate an exemplary embodiment of the invention in which toilet 100 is supplied as a single, optionally two or more, substantially flat pieces which can be assembled into a three dimensional toilet using one hand.

Optionally, seat 110 is folded along flex point 172 and folded base 150 is inserted within folded seat 110. Optionally, the kit may be provided in a disposable bag which protects the pieces from dirt and/or moisture and/or insures that the pieces remain folded and sanitized/hygienic. Optionally, the same bag may be used for disposal of seat 110/waste receptacle 200 after use. Optionally, the bag is biodegradable. Optionally, the same bag may be used for disposal of seat 110, waste receptacle 200 and base 150.

FIG. 10 shows a single piece toilet 100 laid flat and ready for assembly. In an exemplary embodiment of the invention, seat 110 is connected to base 150 by a perforated seam 180. Seam 180 is optionally between a rear edge of seat 110 and base 150.

In the exemplary embodiment depicted in FIG. 10, seat 110 is locked to base 150 by three pairs of matched tabs/grooves (160a/140a; 160b/140b; and 160c/140c). A fourth tab/groove pair 160d/140d locks opposite ends of a sheet together to form base 150. Optionally, tabs 160b and 160c are configured to engage grooves 140b and 140c but not to protrude through seat 110.

Optionally, seat 110 is folded and returned to the bag/envelope in which it was supplied after use. In an exemplary embodiment of the invention, seat 110 and/or base 150 may be placed in a regular garbage can at this stage. Optionally, seat 110 and/or base 150 are constructed of biodegradable and/or recyclable materials and may be discarded in a recycling bin.

As described above, in alternate exemplary embodiments of the invention unfolded seat 110 may either be laid upon base 150 or is locked to base 150.

Alternatively or additionally, seat 110 may either be provided as a separate piece or as a contiguous. extension of base 150 (e.g. FIG. 10).

Optionally, seat 110 is provided separately from base 150 and joining of the two components produces toilet 100. After use the two components are optionally disassembled to facilitate disposal of waste container 200 attached to seat 110. In an exemplary embodiment of the invention, joining includes locking of seat 110 to base 150, for example, by means of 1, optionally 2 or more locking mechanisms (e.g. matching tabs and grooves or other locking mechanisms as described hereinabove).

Optionally, seat 110 is provided separately from base 150 and joining of the two components produces toilet 100 which is discarded as a single piece after use without disassembly. In an exemplary embodiment of the invention, seat 110 is folded at fold line 172 prior to disposal.

Optionally, toilet 100 is provided as an assembled unit including seat 110 and base 150 and the two components are disassembled after use to facilitate disposal of waste receptacle 200 attached to seat 110.

Optionally, joining and/or removal of seat 110 and base 150 are accomplished with one hand.

In an exemplary embodiment of the invention, assembly may be completed with one hand, for example while holding a child in the other hand. Factors possibly contributing to rapid assembly include, but are not limited to, use of materials with a memory which “pop open” to an unfolded configuration, use of tab/groove pairs, small size and light weight. In an exemplary embodiment of the invention, flex points 170 pop open to 90 or 180 degrees (corners and middle sides respectively) by themselves or with slight manual energy input.

In an exemplary embodiment of the invention, toilet 100 is constructed primarily of recyclable and/or biodegradable materials. In an exemplary embodiment of the invention, waste.receptacle 200 is constructed of recyclable and/or biodegradable materials. Optionally, toilet 100 is constructed of at least 70%, optionally at least 80%, optionally at least 90% or lesser or intermediate percentages of biodegradable and/or recyclable materials. Optionally the biodegradable/recyclable materials include one or more of corrugated cardboard, paper, non-woven fabric, plastics (optionally biodegradable plastics) and absorbent gel.

General

According to various exemplary embodiments of the invention, toilet 100 may be constructed in different geometric shapes and in a variety of patterns, materials, sizes, textures and colors. While these design consideration do not necessarily contribute to functionality, design may contribute to user acceptance, especially among young children. For example, visually appealing designs can be used to increase user acceptance, especially among children. Optionally, a potty 100 imprinted with a race car design may be appealing to young boys. Optionally, a potty 100 imprinted with bunnies and kittens design may be appealing to young girls. In an exemplary embodiment of the invention, patterns including themes and/or characters from current children's books and/or movies are employed. Optionally, such commercial tie-ins can reduce product cost and/or justify a premium price for the product.

In an exemplary embodiment of the invention, designs may be provided as, or under, a plastic laminate applied to one or more components of toilet 100. Optionally, the plastic laminate contributes to structural strength.

In an exemplary embodiment of the invention, corrugated cardboard is employed for construction of seat 110 and/or base 150 of toilet 100. One of ordinary skill in the art of engineering will be able to consider a combination of factors such as user weight, desired product dimensions and desired product weight and select suitable cardboard for use in construction.

In an exemplary embodiment of the invention, a toilet 100 designed to support a 165-220 pound user is constructed of corrugated cardboard with double or triple wall structure as explained above. Use of corrugated cardboard to construct weight bearing structure is a well developed field within the art of mechanical engineering. The principles of this field are described in, for example, “Testing methods and Instruments for Corrugated Boards” <http://www.lorentzen-wettre.com >; Fédération Européenne des Fabricants de Carton Ondule (FEFCO )—Testing Methods for corrugated board and boxes <http://www.fefco.org/fileadmin/Fefco/pdfs/Technical_PDF/import anglais.pdf>; “The packing user's handbook” by Frank A. Paine (1991; Chapman & Hall, First edition; Library of Congress Catalog Card Number 98-29397) and: “End Use Performance Standard, (EUPS)/Instituts für Beratung, Forschung, Systemplanung, Verpackungsentwicklung und -prüfung (BFSV) at the Hamburg University of Applied Sciences” <http://www.bfsv.de/bfsv/htdocs/main.php?id=36>. The contents of these references is included herein by reference. Tables 1 and 2 present exemplary characteristics of commercially available corrugated carton of different grades.

TABLE 1
Flat Crush Resistance by Flute type

| | | Flute | Wave separation | Min. flat |
|---|---|---|---|---|
| Flute | No. of flute | height | (wavelength) | crush |
| configuration | per meter | (mm) | (mm) | (N/m²) |
| A (coarse) | 104-125 | 4.5-4.7 | 8.7 | 140 |
| C (medium) | 120-145 | 3.5-3.7 | 7.3 | 165 |
| B (fine) | 150-184 | 2.1-2.9 | 6 | 180 |
| E/F (very fine) | 275-310 | 1.15-165 | 3.3 | 485 |

From “The packing user's handbook” by Frank A. Paine

TABLE 2
Performance Characteristics by board type.

| | | 4-point bending | | | | | | | | |
|---|---|---|---|---|---|---|---|---|---|---|
| | | stiffness (BS) | | Edge Crush test | | Burst Strength | | Flat Crush Test | | |
| | | (geom. mean) | | (ECT) | | Test (Burst) | | (FCT) | | |
| | | ISO 5628: 1990 | | FEFCO 8: 1982 | | FEFCO 4: 1994 | | FEFCO 6: 1985 | | |
| EUPS Code | | | Nm | | kN/m | | kPa | | kPa | Box Compr. |
| Quality | | Nm | Guarant. | kN/m | Guarant. | kPa | Guarant. | kPa | Guarant. | test |
| level | FLUTE | Av | level | Av | level | Av | level | Av | level | (BCT) |
| Board 10 | E | 0.7 | 0.65 | 4.2 | 3.9 | 700 | 600 | 500 | 450 | [symbol] |
| Board 20 | E | 0.9 | 0.84 | 4.8 | 4.5 | 1000 | 850 | 500 | 450 | |
| Board 30 | B | 2.7 | 2.5 | 4.2 | 3.9 | 700 | 600 | 320 | 280 | [symbol] |
| Board 40 | B | 3.0 | 2.8 | 4.6 | 4.3 | 800 | 700 | 320 | 280 | |
| Board 50 | B | 3.3 | 3.1 | 5.4 | 5.0 | 1000 | 850 | 380 | 340 | [symbol] |
| Board 60 | C | 5.5 | 5.1 | 4.6 | 4.2 | 800 | 700 | 230 | 200 | |
| Board 70 | C | 6.5 | 6.0 | 5.4 | 5.0 | 1000 | 850 | 300 | 270 | |
| Board 80 | C | 8.0 | 7.4 | 6.0 | 5.6 | 1300 | 1100 | 300 | 330 | |
| Board 90 | C | 9.0 | 8.4 | 7.0 | 6.5 | 1600 | 1350 | 370 | 330 | |
| Board 100 | BC | 17.0 | 16 | 8.0 | 7.4 | 1100 | 950 | | | [symbol] |
| Board 110 | BC | 22.0 | 20 | 9.5 | 8.8 | 1500 | 1250 | | | |
| Board 120 | BC | 31.0 | 29 | 12.0 | 11 | 1900 | 1600 | | | |

End Use Performance Standard, (EUPS)/Institute of BFSV at the Hamburg University of Applied Sciences

Behavior Modification

Some embodiments of the invention comprise a behavior modification kit including a prize and a disposable toilet or disposable diaper. The prize is optionally a sticker.

In an exemplary embodiment of the invention, the prize is awarded to a child for using the toilet. Optionally, the sticker is provided on the toilet and may be removed after the toilet is used. In an exemplary embodiment of the invention, the prize is awarded to a child for not wetting/soiling clothing and/or for using the toilet. The sticker may be provided, for example, as a perforated removable area in lamination and/or in construction materials employed to construct base 150. Optionally, the lamination includes an adhesive backing at the perforation.

In an exemplary embodiment of the invention, the prize is awarded to a child for not wetting and/or soiling the diaper. The word “diaper” as used here includes also underpants or training pants with an absorbent layer designed to prevent “accidents” from soiling clothes (e.g. “Pull-Ups” by Huggies). Optionally, the diaper is a cloth diaper, optionally provided with plastic pants to cover the cloth. Optionally, prizes are awarded after one or more predetermined time intervals. In an exemplary embodiment of the invention, several prizes are associated with a single diaper. Optionally, the prizes are awarded in ascending value. For example, if the prizes are configured as star shaped stickers, a red star might be awarded after 1 hour, a blue star after 2 hours, a silver star after 4 hours and a gold star after 6 hours.

In an exemplary embodiment of the invention, a single child may use a behavior modification system based upon a disposable diaper concurrently with a behavior modification system based upon toilet 100. Optionally, the two behavior modification systems are combined. A dual behavior modification system rewards the child for not soiling/wetting their diaper at the same time that it rewards the child for correctly using toilet 100.

In the description and claims of the present application, each of the verbs “comprise”, “include” and “have” as well as any conjugates thereof, are used to indicate that the object or objects of the verb are not necessarily a complete listing of members, components, elements or parts of the subject or subjects of the verb.

For purposes of this specification and the accompanying claims, the term “user” refers to a person that eliminates waste through aperture 130 into receptacle 200 and/or to a person that assembles and/or disassembles toilet 100 and/or disposes of receptacle 200 and/or seat 110 and/or base 150. In an exemplary embodiment of the invention, a first user assembles toilet 100 and a second user eliminates waste in toilet 100. Optionally, the first user holds the second user (a child) during assembly of toilet 100.

The present invention has been described using detailed descriptions of embodiments thereof that are provided by way of example and are not intended to necessarily limit the scope of the invention. In particular, numerical values may be higher or lower than ranges of numbers set forth above and still be within the scope of the invention. The described embodiments comprise different features, not all of which are required in all embodiments of the invention. Some embodiments of the invention utilize only some of the features or possible combinations of the features. Alternatively or additionally, portions of the invention described/depicted as a single unit may reside is two or more separate physical entities which act in concert to perform the described/depicted function. Alternatively or additionally, portions of the invention described/depicted as two or more separate physical entities may be integrated into a single physical entity to perform the described/depicted function. Variations of embodiments of the present invention that are described and embodiments of the present invention comprising different combinations of features noted in the described embodiments can be combined in all possible combinations including, but not limited to use of features described in the context of one embodiment in the context of any other embodiment. The scope of the invention is limited only by the following claims.

All publications and/or patents and/or product descriptions cited in this document are fully incorporated herein by reference to the same extent as if each had been individually incorporated herein by reference.

1. A portable toilet, the toilet comprising,
(a) a base adapted to support a weight of a user;
(b) a seat positionable upon the base and adapted to support a weight of the user and including a hole through which waste may be passed by the user; and
(c) a waste receptacle permanently attached to the seat.

2. A toilet according to claim 1, supplied as a kit comprising substantially flat pieces.

3. A kit according to claim 2, wherein the pieces are configured so as to be assembled using one hand.

4. A kit according to claim 3, wherein assembly does not include operation of a locking mechanism.

5. A kit according to claim 3, wherein assembly relies at least partially upon a memory of materials employed in constructing at least a portion of the toilet.

6. A portable toilet characterized by a larger cross section where it is adjacent to a floor than where it is adjacent to a seat.

7. A toilet according to claim 6, constructed primarily of biodegradable materials.

8. A toilet according to claim 6, constructed primarily of recyclable materials.

9. A single sheet of corrugated cardboard adapted for assembly into a toilet according to claim 1.

10. The single sheet of corrugated cardboard of claim 9, wherein the adaptation facilitates the assembly with a single hand of an assembler.

11. The single sheet of corrugated cardboard of claim 9, wherein the adaptation facilitates the assembly by an assembler in a time not exceeding 15 seconds.

12. The single sheet of corrugated cardboard of claim 9, wherein the sheet includes at least one perforated seam which facilitates removal of the seat from the base after use.

13. A portable toilet according to claim 1, wherein the seat is lockable in a closed position with at least one locking component.

14. A portable toilet according to claim 1, wherein the base is locked in an assembled state with at least one locking component.

15. A portable toilet according to claim 1, wherein the seat and the base are locked together by at least one locking component.

16. A portable toilet according to claim 15, wherein the seat and the base are locked together by at least two locking components.

17. A disposable toilet seat, the seat characterized by a permanently attached waste receptacle.

18. A disposable toilet seat, according to claim 17, the seat characterized as being foldable.

19. A disposable toilet seat, according to claim 17, the seat characterized as being rigid.

20. A disposable toilet seat according to claim 17, wherein the waste receptacle includes an absorbent inner layer and a liquid impermeable outer layer.

21. A disposable toilet seat according to claim 17, wherein a fold line is positioned so that folding of the seat along the fold line closes the waste receptacle.

22. A portable toilet seat, the seat characterized by a comfort layer positioned to contact exposed skin of a user during use.

23. A portable toilet seat according to claim 22, wherein the comfort layer covers an edge of a waste aperture.

24. A portable toilet seat according to claim 22, wherein the comfort layer comprises padding.

25. A portable toilet seat according to claim 22, wherein the comfort layer comprises wicking material.

26. A portable toilet seat according to claim 22, wherein the comfort layer comprises at least one layer contiguous with a waste receptacle.

27. A method of assembling a portable toilet, the method comprising:
a) erecting a base by assembling no more than 3 matching parts; and
b) positioning a seat on the base;
wherein a waste receptacle is provided by the performance of (a) and (b).

28. A method according to claim 27, wherein the assembling is performed with 1 hand.

29. A method according to claim 27, performed in not more than 15 seconds.

30. A behavior modification kit, the kit comprising:
a) a single use toilet; and
b) a prize;
wherein the prize is designated as a reward for using the toilet.

31. A kit according to claim 30, wherein the prize includes a sticker.

32. A kit according to claim 31, wherein the sticker is provided on the toilet.

33. A behavior modification kit, the kit comprising:
a) a diaper; and
b) a prize;
wherein the prize is designated as a reward for keeping the diaper clean.

34. A kit according to claim 33, wherein the diaper is a disposable diaper.

35. A kit according to claim 33, wherein the prize includes a sticker.

36. A kit according to claim 35, wherein the sticker is provided on the diaper.

37. A behavior modification kit, the kit comprising:
a) a single use toilet;
b) a toilet prize designated as a reward for using the toilet;
c) a diaper; and
b) a diaper prize designated as a reward for keeping the diaper clean.

38. A kit according to claim 37, wherein the diaper is a disposable diaper.
